(19) United States
(12) Patent Application Publication
(10) Pub. No.: US 2026/0159455 A1
(43) Pub. Date: Jun. 11, 2026

(54) METHOD FOR ACHIEVING A NUTRIENT SALINE SOLUTION FOR PLANTS IN CULTIVATED FIELDS

(71) Applicants: Jhoni Belini, Nova Mutum (BR); Victor Gabriel Belini, Nova Mutum (BR); Vanessa Vitoria Belini, Nova Mutum (BR); Angelo Brizot, III, Lucas do Rio Verde (BR)

(72) Inventor: Jhoni Belini, Nova Mutum (BR)

(21) Appl. No.: 19/356,818

(22) Filed: Oct. 13, 2025

(30) Foreign Application Priority Data
Oct. 14, 2024 (BR) BR1020240213084

(51) Int. Cl. C05F 17/40; A01C 23/04; C05F 5/00; C05G 5/23

(52) U.S. Cl. CPC C05F 17/40; A01C 23/047; C05F 5/002; C05G 5/23

(57) ABSTRACT

A nutrient for sprinkling directly to cultivated plants formed from the combination of the Aloe Vera plant and the banana tree fruit, the banana. Pieces of Aloe Vera leaves are homogenized and stirred to produce fermentation involving enzymes and their pigmentation physiological structures. This natural gelatin is then ground into small particles (8) of approximately 0.1 mm. These particles go through a decanting process with added water, weakening the physiological structure of the Aloe Vera plant. With the addition of more water and another decanting period, this volume of weakened Aloe Vera physiological structure receives an equal volume of banana biomass. Then, it receives more water and goes through another decanting period. Finally, the mixture undergoes mechanical agitation in continuous flow, during which the plant and fruit physiology undergo final structural breakdown and are atomized, resulting in the nutrient saline solution.

### BACKGROUND

This description refers to an invention of a method by which, from the Aloe Vera plant, industrial treatment is conducted through a series of stages so that a volume of its leaves can be mixed with a volume of biomass specifically derived from the treatment of bananas already disclosed in document BR102024004204-2 of Jan. 3, 2024.

This unprecedented mixture is made from the industrial processing of aloe vera and banana leaves. After decanting, it creates a saline solution that is applied to plants. This solution provides health benefits to plants in cultivated fields, such as strengthening roots, increasing vitality, and accelerating growth.

### DESCRIPTION OF THE STATE OF THE ART

One of the deep concerns in the agriculture industry is maintaining healthy conditions for crop flowering. Over time, several products have been developed using both natural elements and natural elements mixed with chemical compositions. These products are intended to be used as nutrients for cultivated plants.

An example of this search for plant health is a 2010 patent document BR 112012010487. This document proposes that rice extracts be initially treated with dissolved silica, followed by a treatment with the addition of hydrogen peroxide to form a rice agricultural polymeric nutrient.

It is known that most of these solutions, such as the one above-mentioned, require the use of chemical or synthetic components, often causing noxious effects to the environment when applied indiscriminately in cultivated fields.

### DESCRIPTION OF THE INVENTION

The invention proposes a saline solution with nutrient action for direct application on cultivated plants, associating two natural elements, i.e., the leaves of the Aloe Vera plant and the fruits of the banana tree. Both elements, extracted from nature and mixed after undergoing specific processes, form the saline solution at hand, which is the subject of the patent, through decanting due to their intrinsic plant and fruit components. This solution is ideal for direct sprinkling over the crop, providing significant cellular protection and stimulating plant energy through foliar nutrition due to its ecologically correct composition (natural components).

The saline solution will now be described in detail after a brief explanation.

The initial figures below, from 1 to 4, refer to the production of banana biomass already disclosed in document BR102024004204-2, as previously explained in the comments section of the state of the art.

### DESCRIPTION OF THE DRAWINGS

FIG. 1—shows the bananas harvested from the banana plant;

FIG. 2—shows the bananas being boiled after they have been reduced and cut into slices to release their soluble structural physiology through cooking;

FIG. 3—shows the grinding stage with their physiological matter being maximally reduced;

FIG. 4—shows the banana biomass achieved after the filtering and subsequent cooling stages.

FIG. 5—shows an illustrative image of the Aloe Vera plant, the leaves of which are picked and cut into pieces;

FIG. 6—shows an image of the stored pieces;

FIG. 7—shows the pieces being transferred to a mixer;

FIG. 8—shows the pieces turned into a mass after being processed in a mixer;

FIG. 8A—shows an illustrative image in accordance with the previous figure;

FIG. 9—shows the mass transferred to a grinder for the formation of particles;

FIG. 10—shows the particles taken to a first decanting stage to weaken the physiological structure of the aloe vera plant;

FIG. 11—shows the particles with a weakened physiological structure being mixed with the banana biomass. This mixture remains decanted for a predefined period, during which its color changes, as shown in detail A, and is then further diluted with added water, as shown in detail B;

FIG. 12—shows the stage of steady flow mechanical agitation, forcing the breakdown of the mixture's particles, atomizing them to form the nutrient saline solution;

FIG. 13—schematically illustrates the nutrient saline solution being packed;

FIG. 14—schematically illustrates the nutrient saline solution being sprayed in the cultivated field.

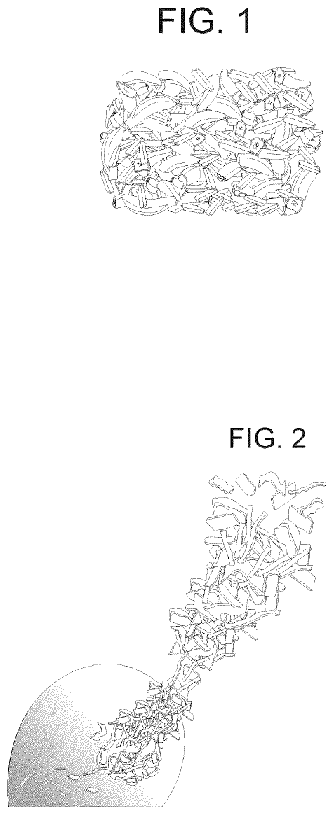

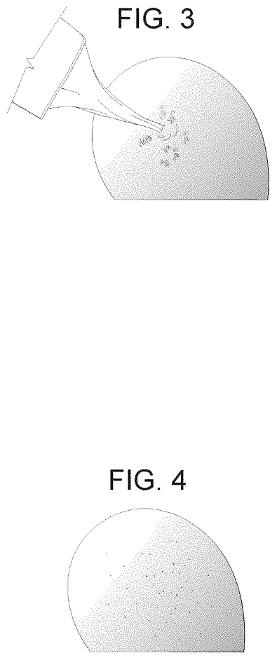

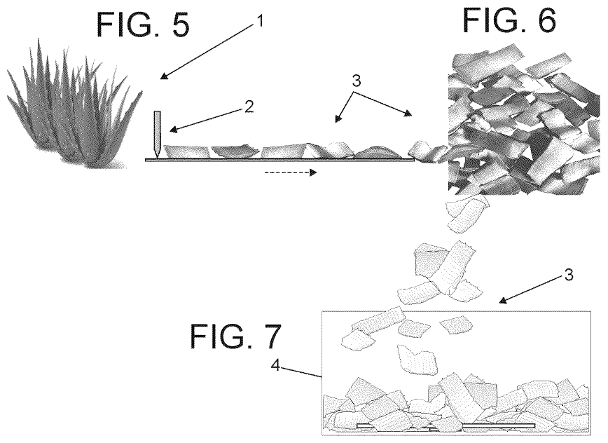

According to the attached figures, the method for achieving a nutrient saline solution for plants in cultivated fields, which is the subject of this patent application, begins with the extraction of the leaves (1) of the Aloe Vera plant, as shown in FIG. 5. These leaves, based on a logical sequence, after being placed on a roller conveyor, are sliced by the blade of a cutting device (2) into pieces (3) of approximately 3 cm, which are then stored in a specific open space in volumes of 1 ton, as shown in FIG. 6. At this stage, the pieces (3) have their exposure to the environment increased, preparing them for the next stage, which is homogenization.

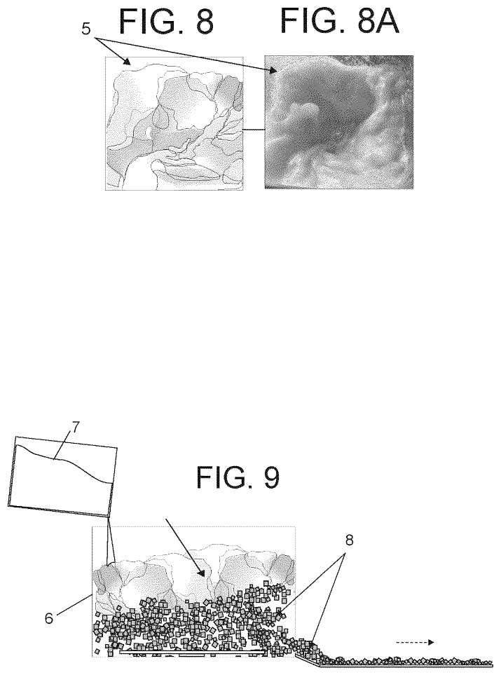

In this stage, in a mixing tank (4), as shown in FIG. 7, the pieces (3) are processed under stirring for approximately 3 days, alternating with one-hour breaks to promote natural fermentation according to the characteristics of the Aloe Vera plant. This process changes the chemical and anatomical properties of the leaf (1) pieces (3), involving pigmentation enzymes and physiological structures. A biological shock occurs after fermentation begins, making the pieces wither and become partially yellowish, with an opaque gelatinous texture. This natural gelatin from the plant's leaf (1) becomes denser, forming a physiological mass (5) as shown in FIGS. 8 and 8A. The physiological mass (5) produced through homogenization is then moved to the next stage, which is grinding.

At this stage, the physiological mass (5) is automatically transferred from the mixer (4) to a grinder (6), as shown in FIG. 9, in volumes of 100 kg, together with the addition of 100 liters of water (7), which acts as a solvent. With a predefined processing time of 30 minutes and the grinder (6) cutting action, the physiology of this mass (5) is reduced, transforming it into small particles (8) around 0.1 mm in size.

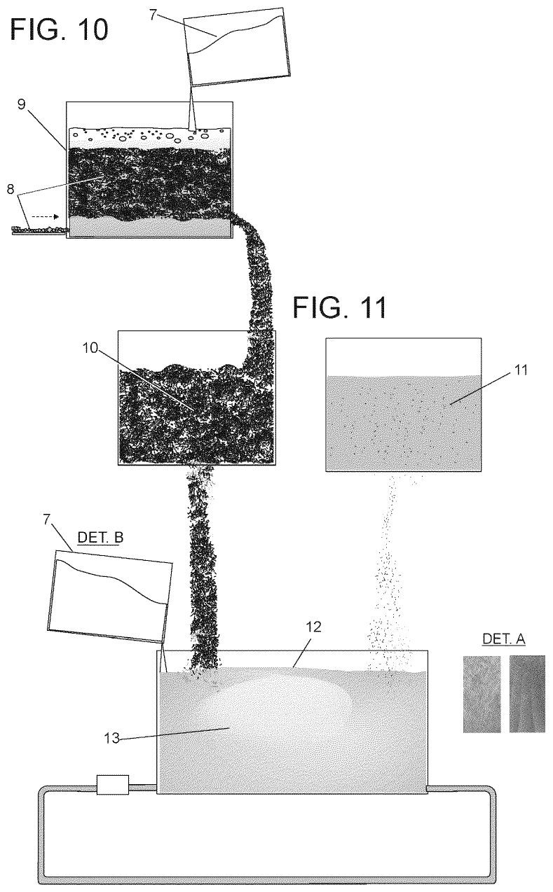

Such small particles (8), in volumes of 100 kg, are automatically transferred from the grinder (6) to a decanting tank (9), with additional water (7) to reach a volume of 200 liters of this solvent (water), as shown in FIG. 10. The mixture remains in this condition for 2 hours, with breaks of 1 hour between periods. Through these two decanting stages, the physiological structure of the Aloe Vera plant (10) is weakened.

In the next stage, displayed in FIGS. 11, 200 liters of this now-weakened physiological structure (10) of the plant are poured, along with 200 liters of banana biomass (11), into another decanting tank (12) with capacity of 1,000 liters, forming a mixture (13) that rests for a period of 2 to 3 days. By the end of this period, it acquires more accentuated coloring. At this stage, as the particles (8) have been reduced to a size of 0.1 mm and their physiological structure has been weakened (10), their adhesion to the banana biomass (10) occurs more effectively. During the decanting process, the mixture (13) color gradually changes from green to light brown, as illustrated in detail A of FIG. 11. As shown in detail B, an additional 600 liters of water are added under these conditions, for a total of 1,000 liters of the mixture (13).

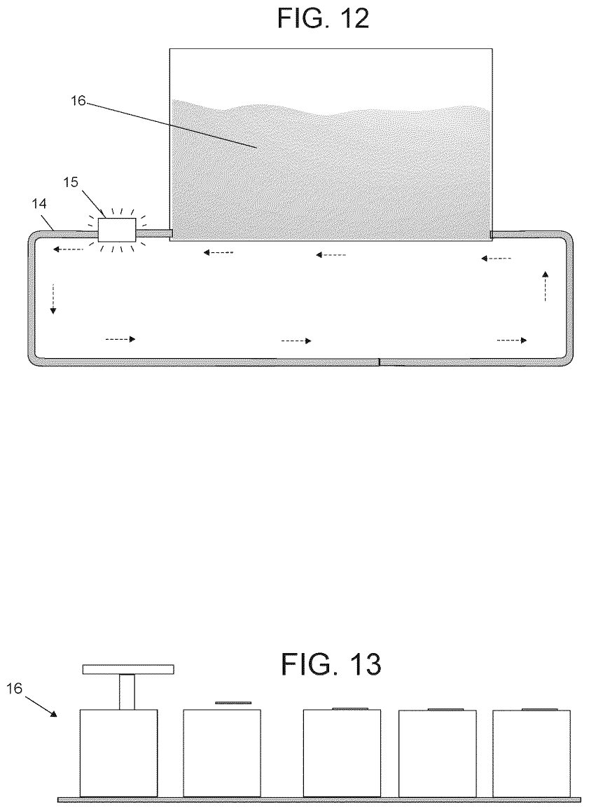

After this stage, the mixture (13) proceeds to the next step as displayed in FIG. 12, where, in the same decanting tank (12) connected by piping (14) to its hydraulic pump (15), the latter, once triggered, causes mechanical agitation in a continuous flow for 30-minute periods with 4-hour intervals for 2 days, as indicated by the arrows. During this time, the mixture (13) of plant and fruit physiology undergoes final breakdown of its structure and is atomized.

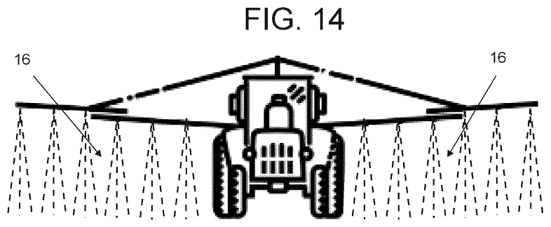

This is how the saline solution (16) is achieved. It is packed as illustrated in FIG. 13 to be supplied to the farmer and applied by sprinkling directly onto the cultivated plant, as displayed in FIG. 14, providing highly effective and ecologically sustainable benefits, without any environmental damage to crops, through the nutrients inherent in the combination of Aloe Vera and banana.

1. (canceled)

2. A method for producing a nutrient saline solution for a plant in a cultivated field, comprising:
extracting leaves from one or more Aloe Vera plants;
cutting the extracted leaves into pieces of approximately 3 centimetres using a cutting device;
storing and exposing the cut pieces in an open-air environment in volumes of approximately one ton;
transferring each one-ton volume of the cut pieces to a mixing tank and homogenizing under stirring for at least three days with intermittent one-hour breaks;
fermenting the homogenized material based on the biochemical characteristics of the Aloe Vera, wherein the fermentation alters the chemical and anatomical properties of the leaf pieces through activation of pigmentation enzymes and physiological changes caused by biological shock, resulting in withered, partially yellowish pieces with a dense, opaque gelatinous texture to form a physiological mass;
transferring the physiological mass in 100-kilogram volumes to a grinder and mixing with 100 liters of water as a solvent, followed by grinding for approximately 30 minutes to reduce the mass into particles having an average size of 0.1 millimeters;
transferring the particles, in volumes of approximately 100 kilograms, to a first decanting tank, adding additional water to reach a volume of 200 liters, and allowing the mixture to decant for two hours with one-hour intervals;
weakening the physiological structure of the Aloe Vera through a decanting process;
mixing 200 liters of the decanted Aloe Vera solution with 200 liters of a banana biomass in a second decanting tank having a capacity of 1,000 liters;
allowing the resulting mixture to rest in the decanting tank for a period of two to three days, during which color changes occur and adhesion of Aloe Vera particles to the banana biomass is enhanced due to prior particle size reduction;
after the resting phase, adding 600 liters of water to the mixture to bring the total volume to 1,000 liters;
mechanically agitating the mixture in continuous flow within the same decanting tank using a hydraulic pump and return piping system, in 30-minute agitation periods spaced by 4-hour intervals, over two days; and
breaking down and atomizing the Aloe Vera and banana biomass structures to produce the nutrient saline solution.

3. The method of claim 2, further comprising packaging the nutrient saline solution for distribution to one or more farmers, and subsequently applying the nutrient saline solution by sprinkling onto a set of cultivated plants in the cultivated field.

4. The method of claim 2, wherein the banana biomass comprises pulp, peel, and a combination thereof.

5. The method of claim 2, wherein the banana biomass is pre-treated by mechanical pulping to enhance the adhesion with Aloe Vera particles during the resting phase.

6. The method of claim 2, wherein the hydraulic pump used for mechanical agitation is configured to maintain a flow rate to enable uniform dispersion and breakdown of biological structures within the decanting tank.
